(19) United States
(12) Patent Application Publication
(10) Pub. No.: US 2011/0094810 A1
(43) Pub. Date: Apr. 28, 2011

(54) Energy retention and release onboard recharging process

(76) Inventor: Steven Michael Hargett, Salem, OR (US)

(21) Appl. No.: 12/586,158

(22) Filed: Oct. 22, 2009

(51) Int. Cl. B60W 10/04; B60W 20/00

(52) U.S. Cl. 180/65.285; 180/65.21

(57) ABSTRACT

This patent concerns the alternating and recharging of an energy retention device. These devices usually retain electrical energy. There are other devices which retain other types of energy to drive a motor in powering a device or a machine. The use of electricity is being applied to this description as an energy source by recharging these energy retention devices once they are depleted of electrical energy in powering an electrical motor in an electrical device or machine. Then, alternating their use as they are recharged creates a longer distance of travel and operation. In an alternating and recharging process these energy devices are utilized until depleted of energy; at that stage, they are recharged. The recharge stage is accomplished by an independent power source. The retention and release of energy in and from a device, which is then recharged by an energy creation source, creates a cycle of operation to which energy is supplied to a motor to drive a machine or device. The cycle repeats itself as long as the energy is delivered to the independent recharging device.

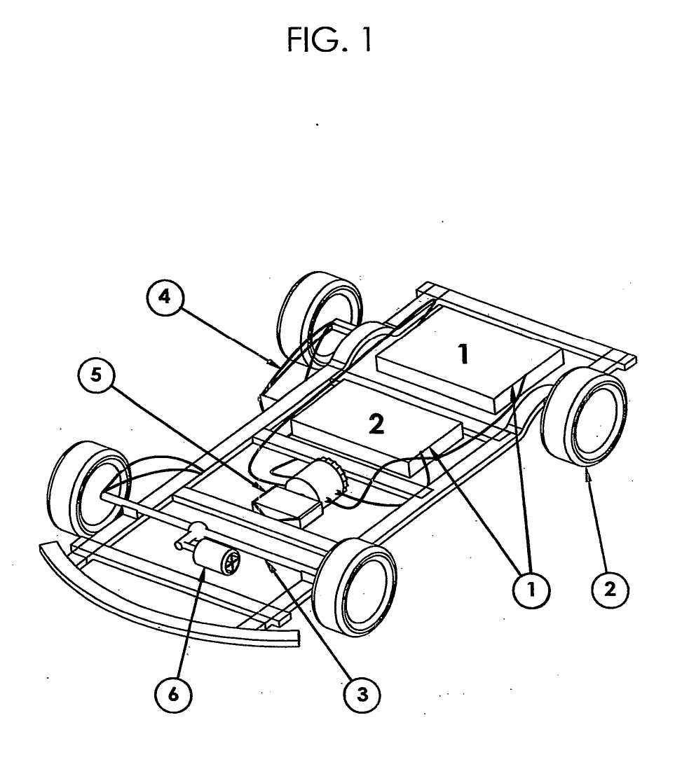

### SUMMARY OF THE INVENTION

This Invention addresses the need to allow an electrically motorized device, electrically powered equipment or machine the means to extend the time of operation. The unacceptability of the electrically operated equipment, devices and/or machines was the length of time they were able to operate. This Invention retains electrical energy in a device and then releases it when needed to power a motor to drive a machine or a device. This Invention is a process of retaining energy which could be of many types. The number of these energy retention devices may be of a number from one to as many as needed to allow the application to cycle itself. The number of devices is determined by what is needed to be completed or accomplished from the motor driving the machine or device. In most cases, it is the time and distance of use which is required. Using electricity as an example, this Invention utilizes a device that creates electricity, attaching the device as an onboard independent electrical device. The electricity-producing device is totally separate of the equipment, electrical drive system, gears or any other aspect of the electrical device or electrical machine. This onboard device creates electricity needed to recharge the energy depleted electricity retaining devices once they are empty from use. The charged devices then restart the operation of supplying energy to the electrical motor in the machine or device. The energy retention devices are held in series of discharge and recharge cycles. The invention retains electrical energy in the devices and releases the electrical energy to drive and electric motor by alternating their use of retention and release in the recycle process.

This invention is a process of alternating the use of the electricity retention devices, in a manner of discharge and recharge. The process lengthens the powering of the operation of the electrical device or machine. Thus, the electrical device or machine can stay in service for longer periods of time increasing its operation. This invention also eliminates the need to stop the operation of the device or machine. This usually requires taking it out of service to recharge the electricity retaining devices once they have been depleted.

### FIELD OF INVENTION

Concerning this Invention, it relates to supplying of electricity generated from an independent power source. This source is a common device known as a generator or gen set. The gen set is twofold: 1) combustion engines, and 2) electric generator. These two devices are coupled together to work as one device for the production of electricity. In this Field of Invention the electricity created is sent to electricity retention devices to be used in the powering of the electrical device or a machine. These electricity retention devices are charged and discharged in a cycle of alternating their use once depleted and recharging the depleted devices once used in powering a motor in a device or machine. Then once recharged brought back into service of powering the electric machine or device.

### PREFERRED EMBODIMENT

Many electrical driven machines have been too costly to operate due to the energy devices which retain the energy to drive the machine or the device. The energy retention and release process is made possible by utilizing an independent, onboard electrical energy producing device. An electrical vehicle is used in this description as an example. The electric vehicle has two separate energy retention devices. The devices temporarily retain energy in the device for the purpose of using the energy retained to drive an electric motor in the electric vehicle as in this example. The retained energy in the first device is used to start and drive the electric vehicle a certain time or distance. When the first energy retaining device has been depleted of its energy from powering the electric vehicle, it is switched into recharging phase. The process of driving the electric vehicle then switches to the second energy retention device. The second energy device then takes over the powering of the electric vehicle. The charging device used is an electricity producing device. The charging device is totally independent of the electric vehicle, however rides along on board of the electric vehicle. The charging device can be any device which produces energy; in this example, electricity. The most notable device is commonly referred to as a generator. The generator shaft is coupled to a shaft of a small combustion engine which when in operation phase, turns the generator shaft to create electricity.

The combustion engine may use a wide variety of fuels to power it, the most common being gasoline. The electricity from the charging device is then directed to charge the first energy retention device which has been depleted. Once recharged, the first energy retention device is ready to re-enter the powering of the motor to drive the electric vehicle. When the second energy device is depleted, it then enters the recharging phase. The first energy retention device by then should be charged and ready to re-enter the powering of the electric vehicle. When the cycle is completed in the first and second retention devices, the cycle starts over. This cycle of energy retention and energy release to drive a motor continues to repeat itself. The cycle will continue as long as the independent charging device is supplied with energy to charge the depleted energy retention devices and return them to drive the motor. To further embody this Invention, the process and its cycle can be achieved by as many energy retention devices as needed to allow the process to cycle.

This invention utilizes an electric generator. This generator is mostly powered by a combustion engine. The most common of these is powered by gasoline, propane, natural gas, diesel or biodiesel. These two devices are coupled together to produce electricity. This device is commonly referred to as a Gen Set. The Gen Set supplies the electricity needed to recharge the empty energy retention devices. These retention devices are commonly referred to as a battery or a capacitor. It must be mentioned that there are many other types of energies that are retained in devices.

This Invention overcomes the need to stop and recharge these energy retention devices, thereby eliminating the need to stop the operation of the electric vehicle to recharge these energy retention devices. A stoppage causes the equipment to be taken out of service and it cannot be used. These energy retention devices are ever-changing to accommodate the need to retain new types of energy. This Invention increases the time of operation by installing an independent electricity producing device on board. This independent onboard device has a sole purpose of recharging the energy retaining devices once depleted. The recharged energy devices are then released back into service to power the electric vehicle, or any other type of equipment.

The range and scope of the Energy Retention and Release Onboard Process can be applied to many types of machines or devices as in the electric vehicle, or military tanks, ships, and all types of electrical devices ranging to even cell phones.

### DESCRIPTION OF DRAWING

FIG. (1) As shown in the example, the drawing is a view looking down on a standard frame of an electric vehicle or, more notably, a motor vehicle. A motor vehicle can be manufactured to use many types of energy to drive its motor. Looking down on FIG. (1), the drawing shows numbered points 1 through 6. Numbers 1 through 6 in FIG. (1) are the components which describe the inventions components of the Energy Retention and Release On Board Recharging Process. These components in the drawing of FIG. (1) are the essential components that allow the motor vehicle's operation and the invention's process to recycle itself.

Number 1 of FIG. (1) directs us to the energy retention devices. Number (1) shows the energy retention devices, which are numbered 1 and 2. The energy retention devices are shown in the shape of a slight rectangle. These energy retention devices are a standard part of the equipment in the electric vehicle's operation. Energy retention devices 1 and 2 are charged with electrical current to power the electric motor (number 6), which drives the electric vehicle. The energy retention devices are used one at a time to power the electric drive motor; their use is a delete/recharge cycle of use.

Number 2 of FIG. (1) shows a wheel and rubber tire which is standard equipment on a motor vehicle.

Number 3 of FIG. (1) shows the drive axle; the drive axle is the component of the electric vehicle that transforms the electrical energy from the electric motor into an action; the action causes the electric vehicle to travel.

Number 4 of FIG. (1) shows the electricity power cables that transfer the electricity being generated from the onboard generator (number 5). The production of electricity by the generator is directed through the electrical power cables to the energy retention devices. The transfer of electricity allows the invention's process to recycle in the retention of the electrical energy and the release of the electrical energy.

Number (5) of FIG. (1); shows the on board generator which generates the electricity to recharge the energy retention devices shown as number (1) in the drawing FIG. (1). Both energy retention devices are recharged at intervals of use; once depleted they are recharged and are placed on standby; placed on standby they are temporarily paused to re-enter the powering of the electric vehicle once the other energy retention device has been depleted.

Number 6 of FIG. (1) shows the electric drive motor which is attached to the electric vehicles drive axle. This electric drive motor receives its electrical current to power the electric vehicle from the energy retention devices (number 1). The drive axle then turns, which in turn causes the wheels and tires to turn as the end result causes the movement of the electric vehicle.

1. The use of a multi-fueled energy creating device which is an independent, separate device used on board a motor vehicle as a power source. The purpose of the on board energy device is used to recharge the empty energy retention devices once they are used and depleted of energy. This claim is based on the ability to independently recharge those same energy retention devices, by not using the energy of the motor vehicle to drive a recharging device.
As in the purpose, to recharge and hold the energy retention devices once charged and then switch them to powering the motor vehicle as the other energy retention devices are depleted. The energy retention devices may be reused repeatedly in the energy retention and energy release cycle. The cycle allows the continuation of the powering of the motor vehicle. The independent on board energy creating device provides the energy for the recycling of the energy retention devices in this invention.

2. The use of multiple energy retention devices and the number of energy retention devices is determined on how many needed to allow the cycle of energy retention and energy release to accomplish its task in the invention's recycling process. These devices are to be used in an energy retention and energy release cycle to power a motor vehicle by using the energy retention devices until depleted from powering a motor vehicle and then recharging them. Then, they are temporarily held until they can re-enter the powering phase of the motor vehicle.
